(19) United States
(12) Patent Application Publication
(10) Pub. No.: US 2026/0054259 A1
(43) Pub. Date: Feb. 26, 2026

(54) PHOTOCATALYTIC STRUCTURE AND METHOD FOR PRODUCING PHOTOCATALYTIC STRUCTURE

(71) Applicant: Sunstar Engineering Inc., Osaka (JP)

(72) Inventors: Asa YAMAMOTO, Osaka (JP); Tomoharu USA, Osaka (JP); Yasuyuki YOSHIMOTO, Osaka (JP)

(73) Assignee: Sunstar Engineering Inc., Osaka (JP)

(21) Appl. No.: 19/104,634

(22) PCT Filed: Jul. 14, 2023
(86) PCT No.: PCT/JP2023/026040

§ 371 Date: Feb. 18, 2025

(30) Foreign Application Priority Data
Aug. 24, 2022 (JP) 2022-133135

(51) Int. Cl. B01J 35/39; B01J 21/06; B01J 35/54; B01J 35/64; B01J 37/02; B01J 37/08

(52) U.S. Cl. CPC B01J 35/39; B01J 21/063; B01J 35/54; B01J 35/657; B01J 37/0215; B01J 37/0236; B01J 37/08

(57) ABSTRACT

A photocatalytic structure according to one embodiment of the present invention, which achieves a high deodorization effect, comprises a base material formed of a porous ceramic material in a platelike shape and a photocatalyst supported on the surface and inside pores of the base material. The open porosity of the ceramic material is 35-75%, the ceramic material includes large pores having a diameter of 100-1000 μm inclusive, and small pores having a diameter of 10 μm or less are open in the inner wall surfaces of the large pores.

### TECHNICAL FIELD

The present invention relates to a photocatalytic structure and a method for producing a photocatalytic structure.

### BACKGROUND ART

Deodorizing devices that obtain a deodorizing effect by decomposing organic matter using a photocatalyst such as titanium oxide have been put into practical use. Such a deodorizing device includes a photocatalytic structure formed by supporting a photocatalyst on the surface of a base material, a light source that emits light to the photocatalytic structure to activate the photocatalyst, and airflow generating means that sucks ambient air and brings it into contact with the photocatalyst. In order to efficiently bring air into contact with a photocatalyst, it has been proposed to use a porous ceramic material as a base material for a photocatalytic structure (for example, see Patent Document 1).

In selecting the ceramic material used as the base material for the photocatalytic structure, emphasis is placed on the material composition, which determines the mechanical properties, and the porosity, which is an index of the surface area and thus the air contact efficiency. Regarding the porosity, Patent Document 1 discloses that a ceramic porous body with a porosity of 85% was used.

### CITATION LIST

### Patent Document

Patent Document 1: Japanese Patent No. 4610135

### DISCLOSURE OF THE INVENTION

### Problems to be Solved by the Invention

Patent Document 1 achieves high porosity as described above while ensuring mechanical strength by forming multiple layers of materials. The pores include open pores (continuous pores) and closed pores (independent pores), and it is not clear what proportion of pores the porosity in Patent Document 1 refers to. However, regardless of the value of the porosity of Patent Document 1, it is difficult to make the porosity of the ceramic material significantly higher than the value of Patent Document 1 in consideration of the mechanical strength. Therefore, in order to further improve the deodorizing effect, a different approach is required. In view of such circumstances, an object of the present invention is to provide a photocatalytic structure having a high deodorizing effect.

### Means for Solving the Problems

A photocatalytic structure according to one aspect of the present invention includes a base material formed of a porous ceramic material in a platelike shape, and a photocatalyst supported on a surface and inside pores of the base material. The ceramic material has an open porosity of 35% or more and 75% or less. The ceramic material has large pores each having a diameter of 100 μm or more and 1000 μm or less. Small pores each having a diameter of 10 μm or less are open to inner wall surfaces of the large pores.

In the photocatalytic structure above, a number of the large pores within an area of 1.8 mm×1.8 mm in a cross section of the ceramic material may be 8 or more and 50 or less.

In the photocatalytic structure above, the base material may have a plurality of through holes penetrating in a thickness direction. The through holes each may have a diameter of 0.7 mm or more and 2.0 mm or less. An area ratio of the through holes with respect to the base material may be 20% or more and 50% or less.

In the photocatalytic structure above, the photocatalyst may contain titanium oxide as a main component. An amount of the photocatalyst supported may be 0.04 g/cm³ or more and 0.15 g/cm³ or less.

A method for producing a photocatalytic structure according to another aspect of the present invention includes immersing a base material formed of a porous ceramic material in a platelike shape, in a photocatalyst dispersion liquid in which photocatalyst particles are dispersed in a solvent, drying the base material, and baking the base material. The ceramic material has an open porosity of 35% or more and 75% or less. The ceramic material has large pores each having a diameter of 100 μm or more and 1000 μm or less. Small pores each having a diameter of 10 μm or less are open to inner wall surfaces of the large pores.

### Effects of the Invention

According to the present invention, a photocatalytic structure having a high deodorizing effect can be provided.

### BRIEF DESCRIPTION OF THE DRAWINGS

FIG. 1 is a schematic perspective view showing a photocatalytic structure according to one embodiment of the present invention;

FIG. 2 is a flowchart showing a procedure for a method for producing the photocatalytic structure of FIG. 1;

FIG. 3 is a cross-sectional scanning electron microscope (SEM) image of the base material of a test sample 1;

FIG. 4 is a cross-sectional SEM image of the base material of a test sample 7;

FIG. 5 is a cross-sectional SEM image of the base material of a test sample 8; and

FIG. 6 is a cross-sectional SEM image of the base material of a test sample 9.

### PREFERRED MODE FOR CARRYING OUT THE INVENTION

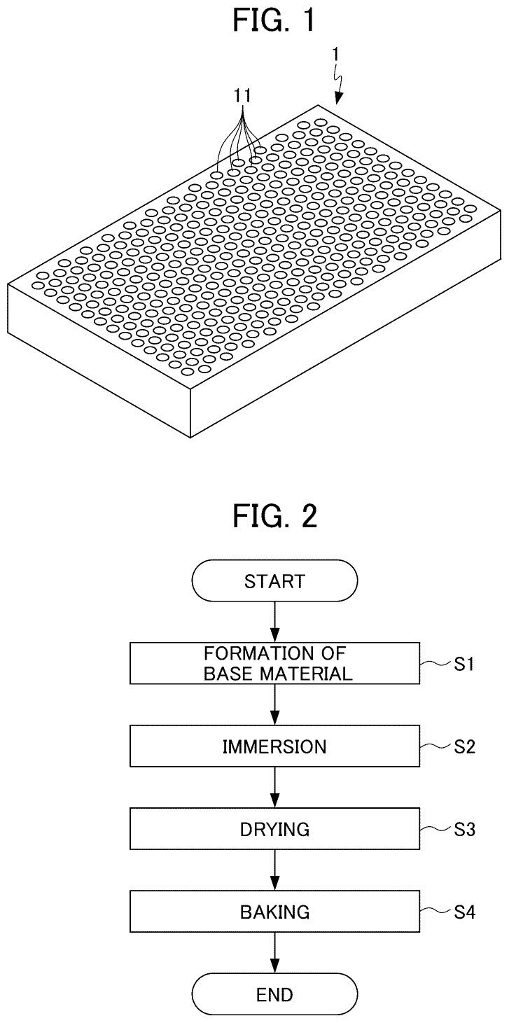

Hereinafter, an embodiment of the present invention will be described with reference to the drawings. FIG. 1 is a schematic perspective view showing a photocatalytic structure 1 according to one embodiment of the present invention.

The photocatalytic structure 1 includes a base material formed of a porous ceramic material in a platelike shape, and a photocatalyst supported on the surface and inside pores of the base material.

By using a porous ceramic or a ceramic material having both pores of 100 μm or more and pores of 10 μm or less as the base material of the photocatalytic structure 1, organic matter in the air can be temporarily adsorbed and held, and the adsorbed organic matter can be decomposed over time by the catalytic effect of the photocatalyst, so that the deodorizing effect can be increased.

The ceramic material forming the base material preferably contains silica, which is relatively inexpensive and can improve mechanical properties, as a main component, and preferably contains alumina that is less expensive. Specifically, the lower limit of the total content of silica and alumina is preferably 60% or more, and more preferably 80%, in order to suppress costs. On the other hand, the upper limit of the total content of silica and alumina is preferably 98%, and more preferably 97%, in order to contain an additive for optimizing the physical properties of the material. The lower limit of the ratio of silica to alumina is preferably 1.0, and more preferably 1.2, in order to improve strength. On the other hand, the upper limit of the ratio of silica to alumina is preferably 3.0, and more preferably 2.5, in order to suppress costs.

The lower limit of the open porosity of the ceramic material forming the base material is preferably 35%, more preferably 40%, and still more preferably 50%. On the other hand, the upper limit of the open porosity of the ceramic material forming the base material is preferably 75%, and more preferably 70%. By setting the open porosity of the ceramic material to the lower limit or more, the amount of the photocatalyst supported inside the pores of the base material can be increased, so that the deodorizing effect (effect of decomposing organic matter by the catalytic effect of the photocatalyst) of the photocatalytic structure 1 can be increased. Further, by setting the open porosity of the ceramic material to the upper limit or less, the mechanical strength of the base material can be ensured. The “open porosity” is measured according to the boiling method of JIS-R1634 (1998).

The ceramic material forming the base material has large pores each having a diameter of 100 μm or more and 1000 μm or less and small pores each having a diameter of 10 μm or less. The existing density distribution of the pore diameter of the ceramic material preferably has a peak of 100 μm or more and 1000 μm or less and a peak of 10 μm or less. In the ceramic material, it is preferable that the small pores are also open to the inner wall surfaces of the large pores. When the pore diameter is too large, the specific surface area of the porous ceramic becomes small, the capacity to adsorb organic matter decreases, and the amount of the photocatalyst that can be supported becomes small. On the other hand, when the pore diameter becomes too small, the photocatalyst dispersion liquid does not penetrate into fine parts, and the amount of the photocatalyst that can be supported becomes small. The existence of the large pores each having a pore diameter of 100 μm or more and 1000 μm or less allows the photocatalyst dispersion liquid to penetrate into the inside, making it possible to efficiently support the photocatalyst. Further, when small pores each having a pore diameter of 10 μm or less are present along with the large pores, the photocatalyst dispersion liquid that has penetrated into the large pores can easily penetrate into the small pores, allowing the photocatalyst to be uniformly supported even in the deep parts of the base material, thereby further increasing the deodorizing efficiency. From such a viewpoint, it is preferable that the number of the large pores is between 8 or more and 50 or less in a square area of 1.8 mm×1.8 mm in a cross section of the porous ceramic. The “pore diameter” is the average of the long diameter and the short diameters of the pore in a scanning electron microscope image of a cross section of the ceramic material. More specifically, the ceramic material was processed into a rod having a cross section of about 10×10 mm, and the rod was cut using a band saw and surface-coated with an ion sputtering apparatus, and then photographed with a scanning electron microscope. The scanning electron microscope used was S3400 manufactured by Hitachi High-Tech Corporation, and an image was taken at 15 kV.

The lower limit of the thickness of the base material is preferably 8 mm, and more preferably 10 mm, in order to ensure strength. On the other hand, the upper limit of the thickness of the base material is preferably 20 mm, and more preferably 15 mm, so that the photocatalyst inside the pores can be irradiated with light to activate the catalytic action.

The base material, and thus the photocatalytic structure 1, have a plurality of through holes 11 penetrating in the thickness direction. The through holes 11 serve as air flow paths and reduce air pressure loss, thereby suppressing the load on a fan that creates air flow. By making the diameter of the through holes 11 small, air enters the pores of the outer base material from the inner peripheral surface of the through holes 11, thereby promoting the deodorizing effect. It is preferable that such through holes 11 are regularly formed at equal intervals over substantially the entire area of the photocatalytic structure 1 except for the outer edge part.

The lower limit of the diameter of the through holes 11 is preferably 0.7 mm, and more preferably 1.0 mm, in order to facilitate the formation. On the other hand, the upper limit of the diameter of the through holes 11 is preferably 2.0 mm, and more preferably 1.5 mm, in order to prevent air from passing through without contacting the photocatalyst. The lower limit of the area ratio of the through holes 11 with respect to the base material is preferably 20%, and more preferably 25%, in order to sufficiently reduce the pressure loss. On the other hand, the upper limit of the area ratio of the through holes 11 with respect to the base material is preferably 50%, and more preferably 40%, in order to promote contact of air with the photocatalyst. Note that the “diameter” is a circle-equivalent diameter, that is, the diameter of a circle having the same area.

The photocatalyst preferably contains titanium oxide having an excellent photocatalytic effect, more specifically, anatase-type titanium dioxide, as a main component. The particle diameter (median diameter) of the photocatalyst is preferably 50 nm or more and 400 nm or less so that the photocatalyst can be introduced into the pores of the base material.

The photocatalyst is substantially uniformly supported on the entire base material. The lower limit of the amount of the photocatalyst supported per volume of the photocatalytic structure 1 (including the internal spaces of the through holes 11) is preferably 0.04 g/cm³, and more preferably 0.06 g/cm³, in order to obtain a sufficient deodorizing effect. On the other hand, the upper limit of the amount of the photocatalyst supported per volume of the photocatalytic structure 1 is preferably 0.15 g/cm³, and more preferably 0.10 g/cm³, in order to uniformly support the photocatalyst without blocking the pores of the ceramic base material.

Since the photocatalytic structure 1 having the above-described configuration holds the photocatalyst uniformly and relatively densely even in the interior thereof, organic matter in the air can be effectively decomposed by the catalytic action of the photocatalyst, and thus the deodorizing effect is high.

The photocatalytic structure 1 is produced by one embodiment of the method for producing a photocatalytic structure according to the present invention shown in FIG. 2. The photocatalytic structure 1 can be produced by a method including a step of forming a base material (step S1: base material forming step), a step of immersing the base material in a photocatalyst dispersion liquid (step S2: immersing step), a step of drying the base material (step S3: drying step), and a step of baking the base material (step S4: firing step).

In the base material forming step of step S1, a base material having a desired porosity and pore diameter and a required outer shape is formed. In the base material forming step, a powder that decomposes at a ceramic calcining temperature is mixed with a known ceramic raw material and molded, and the molded body is calcined to form a porous ceramic having large pores each having a relatively large diameter of 100 μm or more and 1000 μm or less and small pores each having a diameter of 10 μm or less, which are not found in general ceramic materials as described above. As the powder material for forming the large pores, those that decompose at high temperatures, such as sake lees, rice bran, soybean cake, coal, charcoal, and plastics, can be used. The particle diameter of the powder material that determines the diameter of the large pores can be adjusted by adjusting kneading conditions of a kneading machine such as a kneader or an extruder.

In the immersing step of step S2, the base material formed of the porous ceramic material as described above is immersed in a photocatalyst dispersion liquid in which photocatalyst particles are dispersed in a solvent to impregnate the base material with the photocatalyst dispersion liquid. Since the base material is formed of the ceramic material having the large pores and small pores, the catalyst dispersion liquid uniformly penetrates into the base material. As the solvent for the photocatalyst dispersion liquid, for example, 2-propanol, water, or the like can be used. The photocatalyst concentration in the photocatalyst dispersion liquid is preferably 10% or more and 40% or less in order to introduce the photocatalyst at a sufficient density while ensuring the permeability into the base material. The photocatalyst dispersion liquid may contain a binder that promotes adhesion of the photocatalyst particles to the base material.

In the drying step of step S3, the base material impregnated with the photocatalyst dispersion liquid is dried to adhere the photocatalyst particles to the outer surface of the base material and the inner surfaces of the pores. Since the photocatalyst particles may be detached when the solvent of the photocatalyst dispersion liquid is boiled, it is preferable to perform drying at a temperature sufficiently lower than the boiling point of the solvent. As an example, when the solvent of the catalyst dispersion liquid is 2-propanol, drying can be performed at room temperature for 24 hours.

In the baking step of step S4, the base material in which the impregnated catalyst dispersion liquid has been dried is baked to fix the photocatalyst particles to the base material. The baking conditions may be, for example, heating at 500° C. for one hour and then slowly cooling to room temperature. When the base material has the large pores, the photocatalyst after baking is likely to be a continuous layer, and thus the photocatalyst is less likely to fall off from the base material.

As described above, by undergoing the immersing step, the drying step, and the baking step, the photocatalyst can be uniformly supported even in the pores each having a relatively small diameter of the base material. The photocatalytic structure 1 produced by such a method can exhibit a high deodorizing effect as described above.

Although the embodiment of the present invention has been described above, the present invention is not limited to the above-described embodiment, and various modifications and variations are possible.

### EXAMPLES

Hereinafter, the present invention will be specifically described based on Examples, but the present invention is not limited to the following Examples.

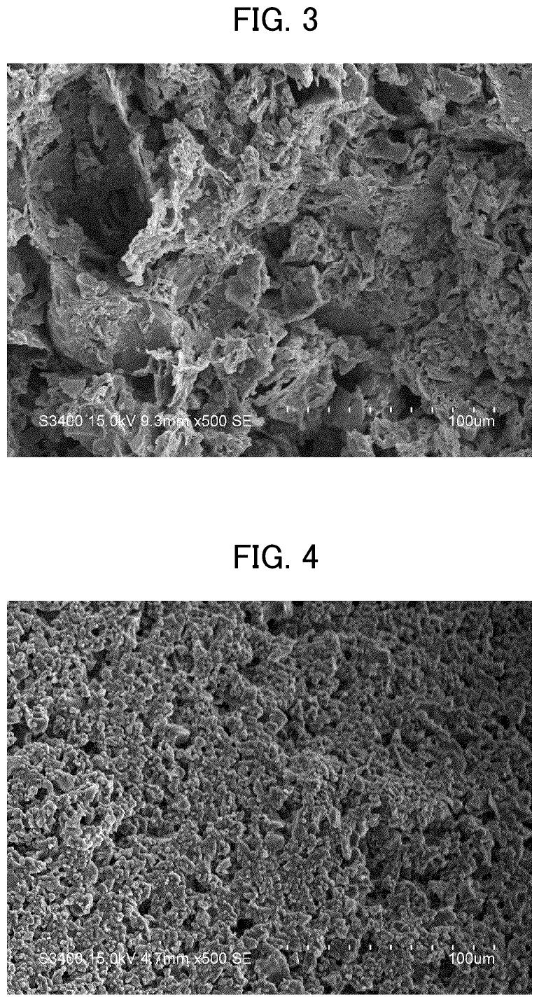

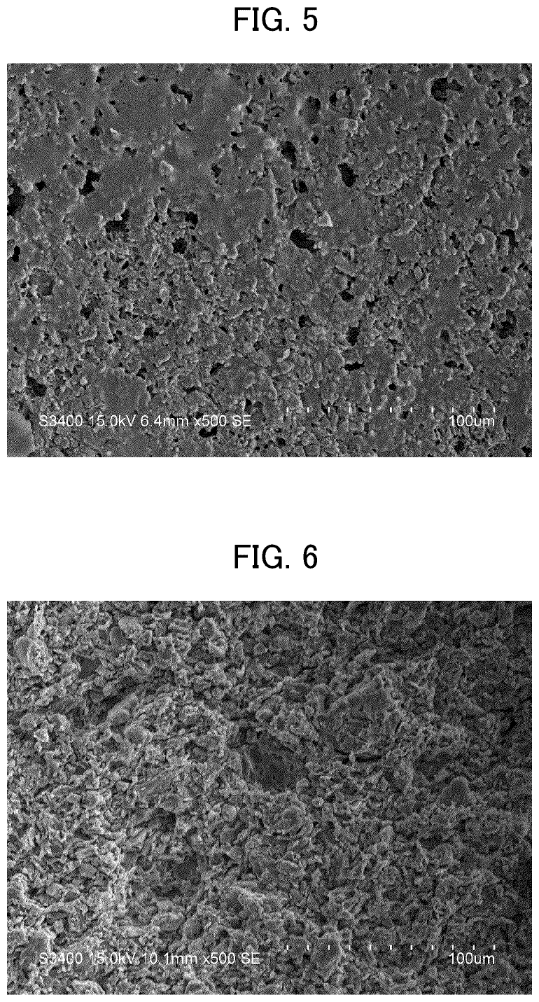

Various base materials formed of ceramic materials were prepared, and test samples 1 to 11 of photocatalytic structures were test sampled according to the procedure shown in FIG. 2. Base materials differing mainly in the porosity and pore diameter of the ceramic material and the area ratio of the through holes were prepared as the base materials. As a representative example showing the differences in pore shape of the ceramic materials, FIGS. 3 to 6 show scanning microscope images of test samples 1, 7, 8, and 9. The “total porosity” is the volume ratio of all pores including closed pores, and the “void ratio” is the total value of the volume ratio of all pores in the material and the volume ratio of the through holes. The “water absorption” is a value measured according to the boiling method of JIS-A1509-3 (2014).

In order to evaluate the deodorization performance of the obtained test sample photocatalytic structures, a test was carried out to decompose ammonia and aldehyde in a sealed container, and the time required for decomposition was measured. The following Table 1 summarizes the composition, physical properties, geometric information of the base material, amount of photocatalyst supported, and deodorization performance of the ceramic material of each test sample. In the table, “-” indicates no measured value, and “120<” indicates that the odorous components could not be decomposed within 120 minutes and the test was terminated.

TABLE 1

| Test Sample Number | | 1 | 2 | 3 | 4 | 5 | 6 | 7 | 8 | 9 | 10 | 11 |
|---|---|---|---|---|---|---|---|---|---|---|---|---|
| Composition of Material [%] | Al₂O₃ | 65 | 65 | 65 | 65 | 65 | 65 | 65 | 65 | 37 | 50 | 100 |
| | SiO₂ | 30 | 30 | 30 | 30 | 30 | 30 | 30 | 30 | 54 | 38 | 0 |
| | Others | 5 | 5 | 5 | 5 | 5 | 5 | 5 | 5 | 9 | 12 | 0 |

| | | | | | | | | | | | |
|---|---|---|---|---|---|---|---|---|---|---|---|
| Open Porosity of Material [%] | 65 | 65 | 72 | 55 | 65 | 65 | 40 | 20 | 85 | 15 | 2 |
| Total Porosity of Material [%] | 75 | 75 | 80 | 68 | 75 | 75 | 57 | 43 | 90 | 15 | 4 |
| Water Absorption of Material [%] | 65 | 65 | 83 | 32 | 65 | 65 | 28 | 20 | 26 | — | 17 |
| Number of Large Pores | 33 | 31 | 27 | 47 | 27 | 31 | 8 | 4 | 0 | 5 | 0 |
| Area Ratio of Through Holes [%] | 32 | 0 | 0 | 0 | 50 | 20 | 0 | 0 | 0 | 53 | 0 |
| Void Ratio of Base Material [%] | 83 | 65 | 72 | 55 | 89 | 78 | 40 | 20 | 90 | 79 | 4 |
| Amount of Photocatalyst Supported [g/cm³] | 0.06 | 0.06 | 0.08 | 0.04 | 0.06 | 0.06 | 0.03 | 0.02 | 0.02 | 0.01 | 0.005 |
| Ammonia Deodorization Performance [minute] | 30 | 35 | 20 | 40 | 30 | 30 | 60 | 90 | 70 | 110 | 120< |
| Acetaldehyde Deodorization Performance [minute] | 45 | 45 | 40 | 50 | 45 | 45 | 60 | 90 | 90 | 100 | 120< |

As described above, it was confirmed that the deodorizing effect of the photocatalytic structure can be improved by setting the pore diameters of the base material within certain ranges.

### EXPLANATION OF REFERENCE NUMERALS

1 photocatalytic structure
11 through hole

1. A photocatalytic structure comprising:
a base material formed of a porous ceramic material in a platelike shape; and
a photocatalyst supported on a surface and inside pores of the base material, wherein
the ceramic material has an open porosity of 35% or more and 75% or less, the ceramic material has large pores each having a diameter of 100 μm or more and 1000 μm or less, and
small pores each having a diameter of 10 μm or less are open to inner wall surfaces of the large pores.

2. A The photocatalytic structure according to claim 1, wherein a number of the large pores within an area of 1.8 mm×1.8 mm in a cross section of the ceramic material is 8 or more and 50 or less.

3. The photocatalytic structure according to claim 1, wherein
the base material has a plurality of through holes penetrating in a thickness direction,
the through holes each have a diameter of 0.7 mm or more and 2.0 mm or less, and
an area ratio of the through holes with respect to the base material is 20% or more and 50% or less.

4. The photocatalytic structure according to claim 1, wherein
the photocatalyst contains titanium oxide as a main component, and
an amount of the photocatalyst supported is 0.04 g/cm³ or more and 0.15 g/cm³ or less.

5. A method for producing a photocatalytic structure, the method comprising:
immersing a base material formed of a porous ceramic material in a platelike shape, in a photocatalyst dispersion liquid in which photocatalyst particles are dispersed in a solvent;
drying the base material; and
baking the base material, wherein
the ceramic material has an open porosity of 35% or more and 75% or less,
the ceramic material has large pores each having a diameter of 100 μm or more and 1000 μm or less, and
small pores each having a diameter of 10 μm or less are open to inner wall surfaces of the large pores.
